(19) United States
(12) Patent Application Publication
(10) Pub. No.: US 2025/0371028 A1
(43) Pub. Date: Dec. 4, 2025

(54) DATABASE SYNCHRONIZATION METHOD AND DEVICE, AND STORAGE MEDIUM

(71) Applicant: Beijing Volcano Engine Technology Co., Ltd., Haidian District (CN)

(72) Inventors: Yun DENG, Beijing (CN); Lei HE, Beijing (CN)

(21) Appl. No.: 19/059,653

(22) Filed: Feb. 21, 2025

(30) Foreign Application Priority Data
Jun. 4, 2024 (CN) 202410718486.6

(51) Int. Cl. G06F 16/27

(52) U.S. Cl. CPC G06F 16/27

(57) ABSTRACT

An incremental log stream of a first database is read and cached into a memory; in any round of iteration, incremental log data in the incremental log stream is sent to a second database in sequence from a first position in the incremental log stream cached in the memory, and a second position of incremental log data which is latest sent to the second database is marked in real time; any to-be-read data block in the first database is read and sending the incremental log data to the second database is paused; old-version data in the to-be-read data block is filtered out based on the incremental log data between the first position and the second position and a preset filtering rule, and filtered data is sent to the second database; and the first position is moved to the current second position and a next round of iteration is continued.

### CROSS-REFERENCE TO RELATED APPLICATION(S)

This application claims priority to Chinese Application No. 202410718486.6 filed Jun. 4, 2024, the disclosure of which is incorporated herein by reference in its entirety.

### FIELD

Embodiments of the present disclosure relate to the technical field of computer and network communication, and in particular, to a database synchronization method and device, and a storage medium.

### BACKGROUND

CDC (Change-Data-Capture) is a technology that pulls a committed incremental log stream (or referred to as change log stream) from a database in real time, and applies an increment to a downstream database, so as to ensure that data of upstream and downstream databases are ultimately consistent. In most databases, a retention time of an incremental log stream is limited, and the incremental log stream does not include full historical data. To obtain all data of upstream data, a full data scan and incremental log stream replay need to be performed to achieve this purpose. Therefore, a CDC technology integrating full and incremental data has emerged.

### SUMMARY

Embodiments of the present disclosure provide a database synchronization method and device, and a storage medium, so as to improve performance of CDC integrating full and incremental data.

In a first aspect, an embodiment of the present disclosure provides a database synchronization method, comprising:
reading an incremental log stream of a first database and caching the incremental log stream into a memory;
in any round of iteration, sending incremental log data in the incremental log stream to a second database in sequence from a first position in the incremental log stream cached in the memory, and marking a second position of incremental log data which is latest sent to the second database in real time, wherein the first position is a start position of sending the incremental log data to the second database in the round of iteration;
reading any to-be-read data block in the first database and pausing sending the incremental log data to the second database, wherein the to-be-read data block includes at least one row of data in the first database;
filtering out old-version data in the to-be-read data block based on the incremental log data between the first position and the second position and a preset filtering rule, and sending filtered data to the second database; and
moving the first position to the current second position and continuing a next round of iteration.

In a second aspect, an embodiment of the present disclosure provides a database synchronization device, comprising:
an incremental log stream reading unit, configured to read an incremental log stream of a first database and cache the incremental log stream into a memory;
a synchronization unit, configured to: in any round of iteration, send incremental log data in the incremental log stream to a second database in sequence from a first position in the incremental log stream cached in the memory, and mark a second position of incremental log data which is latest sent to the second database in real time, wherein the first position is a start position of sending the incremental log data to the second database in the round of iteration;
a data block scanning unit, configured to read any to-be-read data block in the first database and pause sending the incremental log data to the second database, wherein the to-be-read data block includes at least one row of data in the first database;
a filtering unit, configured to filter out old-version data in the to-be-read data block according to the incremental log data between the first position and the second position and a preset filtering rule; and
the synchronization unit is further configured to send the filtered data to the second database, move the first position to the current second position, and continue a next round of iteration.

In a third aspect, an embodiment of the present disclosure provides an electronic device, comprising: at least one processor and a memory;
the memory stores computer-executable instructions; and
the at least one processor executes the computer-executable instructions stored in the memory, to cause the at least one processor to execute the database synchronization method according to the above first aspect and various possible designs of the first aspect.

In a fourth aspect, an embodiment of the present disclosure provides a computer-readable storage medium, the computer-readable storage medium stores computer-executable instructions therein, and when the computer-executable instructions are executed by a processor, the database synchronization method according to the above first aspect and various possible designs of the first aspect is implemented.

In a fifth aspect, an embodiment of the present disclosure provides a computer program product, comprising computer-executable instructions, when the computer-executable instructions are executed by a processor, the database synchronization method according to the above first aspect and various possible designs of the first aspect is implemented.

According to the database synchronization method and device, and the storage medium provided by the embodiments of the present disclosure, an incremental log stream of a first database is read and cached into a memory; in any round of iteration, incremental log data in the incremental log stream is sent to a second database in sequence from a first position in the incremental log stream cached in the memory, and a second position of incremental log data which is latest sent to the second database is marked in real time, wherein the first position is a start position of sending the incremental log data to the second database in the round of iteration; any to-be-read data block in the first database is read and sending the incremental log data to the second database is paused, wherein the to-be-read data block includes at least one row of data in the first database; old-version data in the to-be-read data block is filtered out based on the incremental log data between the first position and the second position and a preset filtering rule, and filtered data is sent to the second database; and the first position is moved to the current second position and a next round of iteration is continued.

### BRIEF DESCRIPTION OF THE DRAWINGS

In order to illustrate the technical solutions in the embodiments of the present disclosure or in the prior art more clearly, the following will briefly introduce the drawings that need to be used in the description of the embodiments or the prior art. Apparently, the drawings in the following description are some embodiments of the present disclosure, and for those of ordinary skill in the art, other drawings can be obtained from these drawings without paying any creative effort.

FIG. 1a and FIG. 1b are schematic diagrams of a DBLog solution in the prior art;

FIG. 2 is a schematic flowchart of a database synchronization method according to an embodiment of the present disclosure;

FIG. 3a, FIG. 3b, and FIG. 3c are schematic diagrams of a database synchronization method according to an embodiment of the present disclosure;

FIG. 4 is a structural block diagram of a database synchronization device according to an embodiment of the present disclosure; and

FIG. 5 is a schematic diagram of hardware structure of an electronic device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and comprehensively below with reference to the drawings in the embodiments of the present disclosure. Apparently, the described embodiments are merely a part of rather than all embodiments of the present disclosure. Based on the embodiments in the present disclosure, all other embodiments obtained by those of ordinary skill in the art without paying any creative effort shall fall within the protection scope of the present disclosure.

A CDC technology integrating full and incremental data has the following features and application scenarios:
a. Replay of an incremental log stream and a full data scan are performed simultaneously, and the same downstream is reused. The downstream does not need to sense the procedures of full data and incremental data, thus the ultimate consistency of data is ensured;
b. The full data scan is triggered at any time, rather than a one-time operation. The full scan can be performed at any time as required. For example, after the downstream data is lost or damaged, re-initiation of a full scan of the upstream data can ensure the consistency of the upstream and downstream data again; and
c. Lock-free. Throughout the process, the upstream and downstream databases remain in a lock-free state, thus achieving good performance.

Existing CDC technologies integrating full and incremental data include a DBLog solution, a Flink CDC 2.0 solution, and the like.

Existing CDC technologies integrating full and incremental data have a problem of processing performance of an incremental log stream.

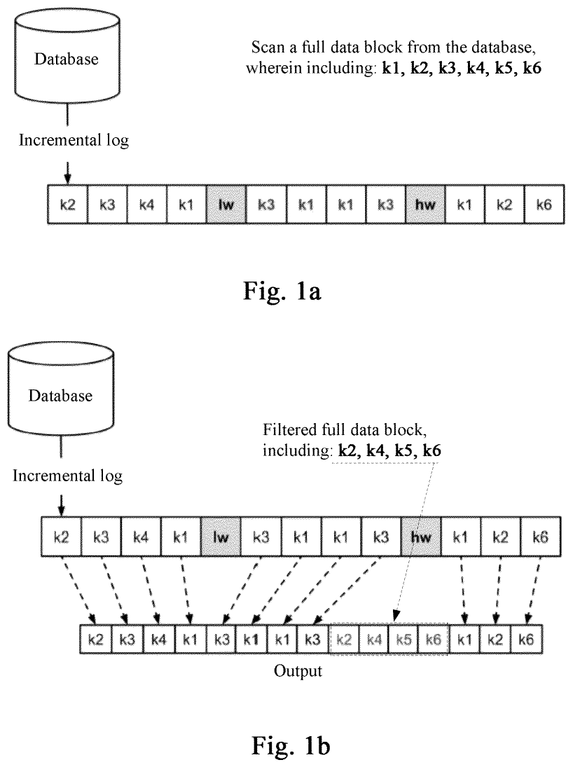

As shown in FIG. 1a and FIG. 1b, the specific process of the DBLog solution is as follows:
i. pausing processing of an incremental log event;
ii. inserting a low watermark event (low watermark, lw) into an incremental log stream (binlog stream);
iii. scanning a full data block from the database;
iv. inserting a high watermark event (high watermark, hw) into the incremental log stream;
v. resuming processing of the incremental log event; and
vi. when a high watermark event identification is executed, filtering the full data block with incremental log data (binlog) between a low watermark event identification and the high watermark event identification, and finding and outputting data that has no intersection with the incremental log data.

Flink CDC 2.0 differs from DBLog in that:
i. checking the incremental log status (executing a show master status command) to obtain the version of the full data; and
ii. the full data can implement single-table concurrency, and scanned data blocks can be processed in batch for alignment.

However, the DBLog solution, the Flink CDC 2.0 solution, and the like have the following problems in the processing performance of an incremental log stream:
1) the DBLog solution will intrude into the upstream incremental log stream when performing version marking on the full data; and
2) the DBLog solution and the Flink CDC 2.0 solution both degrade streaming processing to batch processing, that is, pausing the processing of a log transaction firstly, then performing the full data version marking and scanning, and finally performing the full and incremental data merging and then resuming the processing of the log transaction, resulting in the performance degradation of incremental log stream processing.

In order to solve the above technical problems, the present disclosure provides a database synchronization method and device, and a storage medium. An incremental log stream of a first database is read and cached into a memory; in any round of iteration, incremental log data in the incremental log stream is sent to a second database in sequence from a first position in the incremental log stream cached in the memory, and a second position of incremental log data which is latest sent to the second database is marked in real time, wherein the first position is a start position of sending the incremental log data to the second database in the round of iteration; any to-be-read data block in the first database is read and sending the incremental log data to the second database is paused, wherein the to-be-read data block includes at least one row of data in the first database; old-version data in the to-be-read data block is filtered out based on the incremental log data between the first position and the second position and a preset filtering rule, and filtered data is sent to the second database; and the first position is moved to the current second position and a next round of iteration is continued. In the embodiment, a CDC operation integrating full and incremental data is implemented in a streaming manner without blocking normal processing of a log transaction, so that processing performance of an incremental log stream in CDC operation is improved, and data consistency of the second database is ensured.

The database synchronization method of the present disclosure will be described in detail below with reference to specific embodiments.

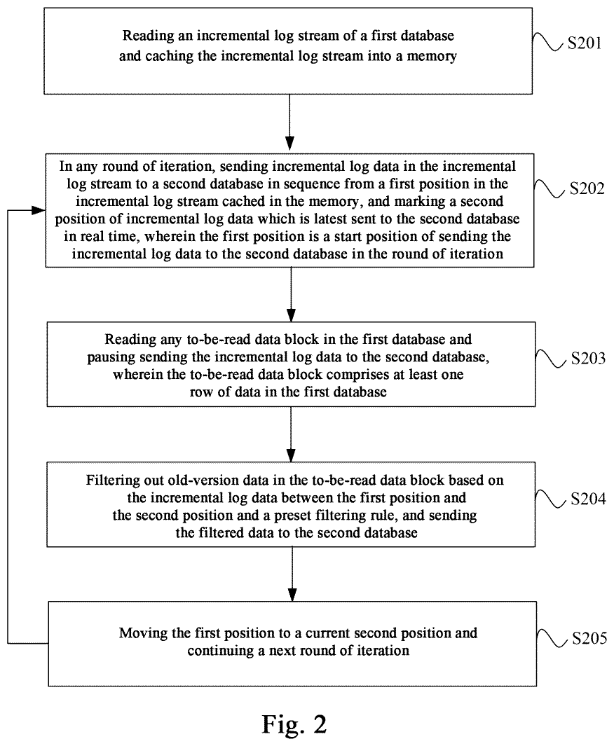

Referring to FIG. 2, FIG. 2 is a schematic flowchart of a database synchronization method according to an embodiment of the present disclosure. The method of this embodiment may be applied to a terminal device or a server, and the database synchronization method comprises the following.

S201: An incremental log stream of a first database is read and cached into a memory.

In this embodiment, the first database and a second database are databases in an upstream and downstream relationship in a service flow, and data consistency needs to be ensured. The incremental log stream of the first database includes logs for performing change operations on the first database, including inserting data, updating data, deleting data, and the like, that is, a Binlog stream (Binlog binary log stream). Among others, the incremental log data in the incremental log stream includes a row identifier of data involved in a change operation, that is, a primary key (Key) of the data, to distinguish different rows.

In this embodiment, when a CDC operation integrating full and incremental data needs to be performed on the first database and the second database, the incremental log stream of the first database may be pulled and cached into the memory. Subsequently, it is only necessary to operate on the incremental log stream cached in the memory, which does not affect the normal operation of the incremental log stream of the first database, and also reduces the intrusion into the incremental log stream of the first database caused by tagging the incremental log stream of the first database as in the DBLog solution.

S202: In any round of iteration, incremental log data in the incremental log stream is sent to a second database in sequence from a first position in the incremental log stream cached in the memory, and a second position of incremental log data which is latest sent to the second database in real time is marked, wherein the first position is a start position of sending the incremental log data to the second database in the round of iteration.

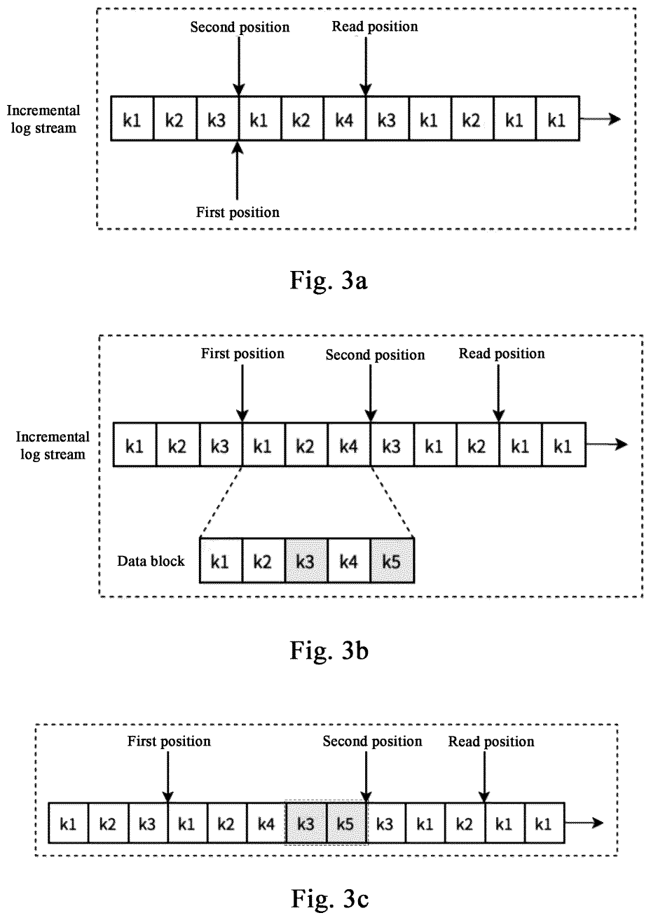

In this embodiment, when a CDC operation integrating full and incremental data is performed, multiple rounds of iteration may be involved. In any round of iteration, incremental log data in the incremental log stream may be sent to the second database in sequence from a first position in the incremental log stream cached in the memory. As shown in FIG. 3a, as long as the incremental log data has low latency, the version of the incremental log data will not be earlier than the version of the current full data. Therefore, the incremental log data is sent to the second database, so that the second database can perform replay according to the incremental log data, that is, the second database captures data changes according to the incremental log data, and synchronizes these changes to the second database.

In the process of sending incremental log data in the incremental log stream cached in the memory to the second database, a second position of incremental log data which is latest sent to the second database may be marked in real time, as shown in FIG. 3a to FIG. 3b.

Optionally, in this embodiment, a first identification may be added to the incremental log stream cached in the memory to mark the start position (the first position) of sending the incremental log data to the second database in the round of iteration. That is, the first identification is added to the first position in the incremental log stream in the memory, and then the incremental log data in the incremental log stream is sent to the second database in sequence from the first identification.

In the process of sending incremental log data in the incremental log stream cached in the memory to the second database, a second identification may be added to the incremental log stream in the memory, so as to mark the second position of incremental log data which is latest sent to the second database in real time through the second identification, and update the position of the second identification in real time along with the sending of the incremental log data.

S203: Any to-be-read data block in the first database is read and sending the incremental log data to the second database is paused, wherein the to-be-read data block includes at least one row of data in the first database.

In this embodiment, the full data in the first database may be divided into multiple data blocks in advance, where any data block includes at least one row of data. In any round of iteration, any to-be-read data block in the first database may be read, and the to-be-read data block may be any data block that has not been read in the first database. Optionally, data blocks in the first database may be read in sequence, and the read to-be-read data block may also be cached into the memory.

After the to-be-read data block is read, sending the incremental log data to the second database is paused, that is, the second position (the position of the second identification) is locked, so as to avoid reading to-be-read data block which is not affected by the subsequent incremental log data, and enable the to-be-read data block to be comparable with the incremental log data between the first position and the second position.

S204: Filtering out old-version data in the to-be-read data block according to the incremental log data between the first position and the second position and a preset filtering rule, and sending filtered data to the second database.

In this embodiment, for the read to-be-read data block, there may be data that is repeated with the incremental log data sent to the second database in the round of iteration (the incremental log data between the first position and the second position), or there may be data that is not repeated. Therefore, in this embodiment, the to-be-read data block may be filtered according to the incremental log data between the first position and the second position. The objective of filtering is to filter out old-version data in the to-be-read data block and send filtered data to the second database.

Optionally, the principle of filtering is as follows.

Firstly, some key technical terms are defined.

Data record (Record): Record=(k, v), the basic unit of CDC, represents a data record with a primary key (key) of k and a version of v by a binary group of k and v;

Dataset: Dataset={(k₁, v₁), . . . , (kᵢ, vⱼ)}, which represents a set of data records;

Apply operation: merging a data record into a dataset using an OVERWRITE semantic, that is, new data will replace old data to ensure that data in the dataset is the latest, specifically as follows:

$$Dataset + ( k , v ) = \{ \begin{matrix}Dataset ⋃ ( k , v ) & ( k ∉ keys in Dataset ) \\ Dataset - ( k , {v}^{′} ) ⋃ ( k , v ) & ( ( k , {v}^{′} ) ∈ Dataset )\end{matrix}$$

A well-structured Apply operation will not cause version rollback, specifically as follows:

$$Dataset + ( k , v ) = \{ \begin{matrix}Dataset ⋃ ( k , v ) & ( k ∉ keys in Dataset ) \\ Dataset - ( k , {v}^{′} ) ⋃ ( k , v ) & ( ( k , {v}^{′} ) ∈ Dataset , {v}^{′} < v )\end{matrix}$$

Logic log stream (LogicLogStream): LogicLogStream=(k₁, v₁), . . . , (kᵢ, vⱼ), a sequence of data records, with versions increasing. The logic log stream may be regarded as an abstraction of an incremental log stream, or may be replaced with the incremental log stream.

Based on the above technical terms, full data and incremental data are simultaneously performed Apply operation, and performing Apply operation on the full data filters out the non-well-structured data while retaining the well-structured data, thus achieving the ultimate consistency of data.

The following is obtained by pulling from the incremental log stream of the first database:

$$LogicLogStream = ( {k}_{i} , {v}_{1} ) , … , ( {k}_{j} , vh ) \qquad ( {v}_{1} < {v}_{h} )$$

The following is obtained from the full data scan:

$$ScanDataset = \{ ( {k}_{i}^{′} , {v}_{1}^{′} ) , … , ( {k}_{j}^{′} , {v}_{h}^{′} ) \} \qquad ( {v}_{1}^{′} < {v}_{h}^{′} )$$

To ensure that the Apply operation of all full data keys is well-structured, the following two points need to be ensured:
1) for k′ᵢ in the full data that does not exist in the incremental log stream, ensure that v′₁>v₁; and
2) for k′ᵢ in the full data that exists in the incremental log stream, since the version of each full data cannot be known, k′ᵢ in the full data is directly discarded to avoid non-well-structured full data Apply operation.

Therefore, the calculation formula for the merge operation of the incremental log stream and the full data is as follows:

$$LogicLogStream + ScanDataset =$$

$$LogicLogStream + ( {k}^{′} , {v}^{′} ) \qquad ( {v}^{′} > {v}_{1} \& {k}^{′} ∈ keys in ScanDataset \& {k}^{′} ∉ keys in LogicLogStream )$$

wherein LogicLogStream here is the Dataset in the above Apply operation.

It can be seen from the above formula that the incremental+full merged calculation does not need to rely on the high watermark version vₕ, so the high watermark tagging operation can be cancelled compared with DBLog. Next, it is proved that the above calculation can make CDC operation data ultimately consistent, mainly proving two points:
1) each piece of data can achieve ultimate consistency
1.1) performing an Apply operation on the incremental log stream can ensure that all Apply operations are well-structured, and all keys in the incremental log stream can achieve ultimate consistency; and
1.2) performing an Apply operation on the full data:
1.2.1) if a certain key only exists in the full data, but not in the incremental log stream, the version of the key in the full data is the latest and can be ultimately consistent; and
1.2.2) for keys that have an intersection between the full data and the incremental log stream:
1.2.2.1) if the data version of the key in the full data is less than the data version of the key in the currently committed incremental log stream, the key in the full data can be skipped, and the incremental log stream ensures the ultimate consistency of data; and
1.2.2.2) if the data version of the key in the full data is greater than or equal to the data version of the key in the currently committed incremental log stream, the key in the full data may only be a version of an increment behind the incremental log stream, which is necessarily less than or equal to the ultimate version of the key data, so the consistency of data can be ensured by the incremental log stream.
2) the dataset keys are consistent

Because it has been proved above that each piece of data can achieve ultimate consistency, this situation can only occur when the first database at the source end does not scan the data, indicating that there is a delete operation, there is incremental data, which conflicts with the ultimate consistency of the incremental data.

Based on the above principle, in the present embodiment, on the basis of sending the incremental log data between the first position and the second position to the second database, the old-version data in the to-be-read data block is filtered out based on the incremental log data between the first position and the second position, and the filtered data is sent to the second database, so that data consistency can be ensured.

In an optional embodiment, the filtering process may be specific as follows:
filtering out data in the to-be-read data block whose primary key is included in the primary key of the incremental log data between the first position and the second position; and filtering out data in the to-be-read data block whose primary key is not included in the primary key of the incremental log data between the first position and the second position and whose time stamp is not greater than the time stamp corresponding to the first identification.

Specifically, referring to the above formula:

$$LogicLogStream + ScanDataset =$$

$$LogicLogStream + ( {k}^{′} , {v}^{′} ) \qquad ( {v}^{′} > {v}_{1} \& {k}^{′} ∈ keys in ScanDataset \& {k}^{′} ∉ keys in LogicLogStream )$$

Based on the above formula, data in the to-be-read data block that does not satisfy the condition of (v′>vᵢ & k′∈keys in ScanDataset & k′∉keys in LogicLogStream) may be filtered out, including data of k′∈keys in LogicLogStream and/or v′≤v₁ in the to-be-read data block. Among others, k′∈keys in LogicLogStream represents data whose primary key is included in the primary key of the incremental log data (LogicLogStream) between the first position and the second position, and v′≤v₁ represents data whose time stamp (or version) is not greater than the time stamp corresponding to the first identification. Through filtering, the filtered data satisfies the condition of (v′>v₁ & k′∈keys in ScanDataset & k′∉keys in LogicLogStream).

In another optional embodiment, data satisfying the condition of (v′>v₁ & k′∈keys in ScanDataset & k′∉keys in LogicLogStream) may also be directly selected from the to-be-read data block, thereby filtering out data that does not satisfy this condition. Specifically, data in the to-be-read data block whose primary key is not included in the primary key of the incremental log data (LogicLogStream) between the first position and the second position (that is, k′ keys in LogicLogStream) and whose time stamp is greater than the time stamp corresponding to the first identification (that is, v′>v₁) may be used as the filtered data and sent to the second database.

For example, as shown in FIG. 3b to FIG. 3c, the obtained to-be-read data block includes k1, k2, k3, k4, and k5, while the incremental log data between the first position and the second position includes k1, k2, and k4. After the to-be-read data block is filtered based on the incremental log data between the first position and the second position, the remaining k3 and k5 are sent to the second database.

S205: The first position is moved to the current second position and a next round of iteration is continued.

In this embodiment, after the filtered data is sent to the second database in the current round of iteration, the first position may be moved to the current second position, so that the new first position is used as the start position of sending the incremental log data to the second database in the next round of iteration, and then the next round of iteration is continued. The incremental log data in the incremental log stream continues to be sent to the second database in sequence from the new first position, and the second position of the incremental log data which is latest sent to the second database continues to be marked in real time, that is, the second position (the position of the second identification) is unlocked. Then, another to-be-read data block is read from the first database, and then sending the incremental log data to the second database is paused, followed by filtering and sending, which will not be repeated here, and so on.

Optionally, when the first identification and the second identification are marked in the memory, the first position may be moved to the current second position by moving the first identification to the current second identification.

The above end condition of the multiple rounds of iteration may specifically include at least any of the following end conditions.

### End Condition 1:

The iteration process ends after all data blocks in the first database are completely read. That is, one data block in the first database is read in each iteration process, and when all data blocks in the first database are completely read, the iteration process ends, and subsequently, only the incremental log data needs to be continuously sent to the second database.

### End Condition 2:

The iteration process ends in the case that there is no incremental log data in the incremental log stream to be sent to the second database and there are still remaining to-be-read data blocks in the first database. That is, there is no new incremental log data in the incremental log stream to be sent to the second database, but at this time, there are still remaining to-be-read data blocks in the first database. Even if the iteration process is performed, the timestamps of data in the data block read from the first database are greater than the timestamp corresponding to the first identification, and all data in the data block will be sent to the second database. Therefore, there is no need to perform the iteration process, but directly send all remaining to-be-read data blocks in the first database to the second database. If new incremental log data can be read from the incremental log stream subsequently, the read new incremental log data may be directly sent to the second database.

According to the database synchronization method provided in the above embodiment, an incremental log stream of a first database is read and cached into a memory; in any round of iteration, incremental log data in the incremental log stream is sent to a second database in sequence from a first position in the incremental log stream cached in the memory, and a second position of incremental log data which is latest sent to the second database is marked in real time, wherein the first position is a start position of sending the incremental log data to the second database in the round of iteration; any to-be-read data block in the first database is read and sending the incremental log data to the second database is paused, wherein the to-be-read data block includes at least one row of data in the first database; old-version data in the to-be-read data block is filtered out based on the incremental log data between the first position and the second position and a preset filtering rule, and filtered data is sent to the second database; and the first position is moved to the current second position and a next round of iteration is continued. In the embodiment, CDC operation integrating full and incremental data is implemented in a streaming manner without blocking normal processing of a log transaction, so that processing performance of an incremental log stream in CDC operation is improved, and data consistency of the second database is ensured.

Based on the database synchronization method provided in the above embodiment, the quick marking manner in the DBLog solution may be used, and it is not necessary to execute checking the incremental log status (executing the show master status command) to obtain the version of the full data as in Flink CDC 2.0, nor is it necessary to perform complex site comparison as in DBLog. This embodiment is implemented based on the logic that the version (time stamp) of the data block read from the first database is necessarily greater than the version (time stamp) of the corresponding data at the first identification. Moreover, in this embodiment, there is no need for a high watermark identification in the DBLog solution, and as long as the increment has low latency, the frequency of version rollback will be reduced.

In addition, in the above embodiment, after any to-be-read data block in the first database is read, sending the incremental log data to the second database may not be paused, and it is only necessary to record which incremental log data is consumed when filtering the to-be-read data block is required. Then, the incremental log data continues to be consumed in the next iteration process, so that the entire process is processed in a streaming manner, and the processing performance of the incremental log stream is improved.

In addition, in the above embodiment, the first database may be read and filtered separately according to the dimension of a data table, and different data tables may also be read and filtered in parallel, so as to improve processing efficiency.

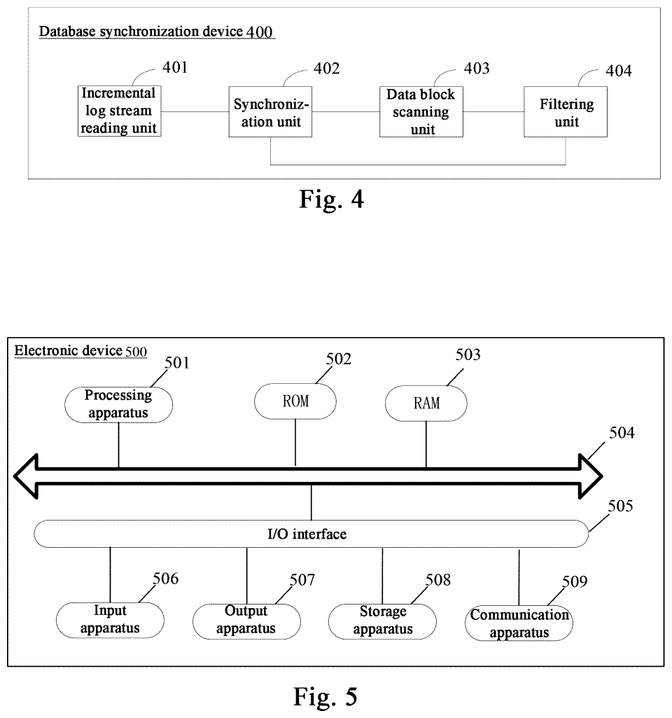

Corresponding to the database synchronization method in the above embodiment, FIG. 4 is a structural block diagram of a database synchronization device provided by an embodiment of the present disclosure. For ease of description, only parts related to the embodiments of the present disclosure are shown. Referring to FIG. 4, the database synchronization device 400 comprises: an incremental log stream reading unit 401, a synchronization unit 402, a data block scanning unit 403, and a filtering unit 404.

Among others, the incremental log stream reading unit 401 is configured to read an incremental log stream of a first database and cache the incremental log stream into a memory.

The synchronization unit 402 is configured to: in any round of iteration, send incremental log data in the incremental log stream to a second database in sequence from a first position in the incremental log stream cached in the memory, and mark a second position of incremental log data which is latest sent to the second database in real time, wherein the first position is a start position of sending the incremental log data to the second database in the round of iteration.

The data block scanning unit 403 is configured to read any to-be-read data block in the first database and pause sending the incremental log data to the second database, wherein the to-be-read data block includes at least one row of data in the first database.

The filtering unit 404 is configured to filter out old-version data in the to-be-read data block based on the incremental log data between the first position and the second position and a preset filtering rule.

The synchronization unit 402 is further configured to send filtered data to the second database, move the first position to the current second position, and continue a next round of iteration.

In one or more embodiments of the present disclosure, the filtering unit 404, when filtering out the old-version data in the to-be-read data block based on the incremental log data between the first position and the second position and the preset filtering rule, is configured to:
filter out data in the to-be-read data block whose primary key is included in the primary key of the incremental log data between the first position and the second position; and
filter out data in the to-be-read data block whose primary key is not included in the primary key of the incremental log data between the first position and the second position and whose time stamp is not greater than the time stamp corresponding to the first identification.

In one or more embodiments of the present disclosure, the filtering unit 404 is configured to:
determine data in the to-be-read data block whose primary key is not included in the primary key of the incremental log data between the first position and the second position and whose time stamp is greater than the time stamp corresponding to the first identification as the filtered data, to be sent to the second database.

In one or more embodiments of the present disclosure, the synchronization unit 402 is further configured to:
end the iteration process after all data blocks in the first database are completely read, and continue to send incremental log data to the second database.

In one or more embodiments of the present disclosure, the synchronization unit 402 is further configured to:
end the iteration process and send the remaining to-be-read data block to the second database in the case that there is no incremental log data in the incremental log stream to be sent to the second database and there are still remaining to-be-read data blocks in the first database; and
continue to send the newly read incremental log data to the second database when new incremental log data is read from the incremental log stream.

In one or more embodiments of the present disclosure, the synchronization unit 402, when in any round of iteration, sending incremental log data in the incremental log stream to the second database in sequence from the first position in the incremental log stream, is configured to:
add a first identification to the first position in the incremental log stream in the memory, and send incremental log data in the incremental log stream to the second database in sequence from the first identification;
the synchronization unit 402, when marking the second position of the incremental log data which is latest sent to the second database in real time, is configured to:
add a second identification to the second position in the incremental log stream in the memory, and update the position of the second identification in real time; and
the synchronization unit 402, when moving the first position to the current second position, is configured to:
move the first identification to the current second identification.

In one or more embodiments of the present disclosure, the data block scanning unit 403, before reading any to-be-read data block in the first database, is further configured to:
divide data in the first database into multiple data blocks, wherein any data block includes at least one row of data.

The device provided in this embodiment may be used to implement the technical solutions of the above method embodiments, and the implementation principles and technical effects thereof are similar, which will not be repeated in this embodiment.

Referring to FIG. 5, it shows a schematic diagram of the structure of an electronic device 500 suitable for implementing the embodiments of the present disclosure, and the electronic device 500 may be a terminal device or a server. Among others, the terminal device may include, but is not limited to, mobile terminals such as a mobile phone, a laptop, a digital broadcast receiver, a personal digital assistant (abbreviated as PDA), a tablet computer, a portable media player (abbreviated as PMP), a vehicle-mounted terminal (such as a vehicle-mounted navigation terminal), and the like, and stationary terminals such as a digital TV, a desktop computer, and the like. The electronic device shown in FIG. 5 is only an example and should not impose any limitation on the function and scope of use of the embodiments of the present disclosure.

As shown in FIG. 5, the electronic device 500 may comprise a processing apparatus (such as a central processing unit and a graphics processor, etc.) 501, which may perform various appropriate actions and processing according to a program stored in a read-only memory (abbreviated as ROM) 502 or a program loaded from a storage apparatus 508 into a random access memory (abbreviated as RAM) 503. The RAM 503 also stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, a gyroscope, etc.; an output apparatus 507 including, for example, a liquid crystal display (abbreviated as LCD), a speaker, a vibrator, etc.; a storage apparatus 508 including, for example, a magnetic tape, a hard disk, etc.; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all of the illustrated apparatuses. Alternatively, more or fewer apparatuses may be implemented or provided.

In particular, according to an embodiment of the present disclosure, the process described above with reference to the flowcharts may be implemented as a computer software program. For example, an embodiment of the present disclosure includes a computer program product, which includes a computer program carried on a computer-readable medium, and the computer program includes program codes for executing the method shown in the flowcharts. In such an embodiment, the computer program may be downloaded and installed from the network through the communication apparatus 509, or may be installed from the storage apparatus 508, or may be installed from the ROM 502. When the computer program is executed by the processing apparatus 501, the above functions defined in the method of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program that may be used by or in combination with an instruction execution system, apparatus or device. In the present disclosure, the computer-readable signal medium may include a data signal propagated in a baseband or as a part of a carrier, and carries computer-readable program codes therein. The data signal propagated in this manner may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained on the computer-readable medium may be transmitted by any suitable medium, including but not limited to an electrical wire, an optical cable, a radio frequency (RF), etc., or any suitable combination thereof.

The above computer-readable medium may be included in the above electronic device, or may exist alone without being assembled into the electronic device.

The above computer-readable medium carries one or more programs, and when the above one or more programs are executed by the electronic device, the electronic device is caused to execute the method shown in the above embodiments.

The computer program codes for executing the operations in the present disclosure may be written in one or more programming languages or a combination thereof. The above programming languages include object-oriented programming languages such as Java, Smalltalk, and C++, as well as conventional procedural programming languages such as C or similar programming languages. The program code may be executed entirely on the user's computer, partly on the user's computer, as a stand-alone software package, partly on the user's computer and partly on a remote computer, or entirely on the remote computer or server. In the scenario involving the remote computer, the remote computer may be connected to the user's computer through any kind of network, including a local area network (abbreviated as LAN) or a wide area network (abbreviated as WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, program segment, or part of codes, and the module, program segment, or part of codes contains one or more executable instructions for implementing specified logical functions. It should also be noted that, in some alternative implementations, the functions marked in the blocks may also occur in an order different from those marked in the drawings. For example, two blocks shown in succession can, in fact, be executed substantially concurrently, or the two blocks can sometimes be executed in a reverse order, depending on the functionality involved. It should also be noted that, each block in the block diagrams and/or flowcharts and a combination of blocks in the block diagrams and/or flowcharts may be implemented by a dedicated hardware-based system that performs specified functions or operations, or may be implemented by a combination of dedicated hardware and computer instructions.

The units involved in the embodiments described in the present disclosure may be implemented by software or hardware. The name of a unit does not constitute a limitation of the unit itself under certain circumstances. For example, a first acquisition unit may also be described as “a unit for acquiring at least two Internet protocol addresses”.

The functions described herein above may be executed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include, but are not limited to: an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

In a first aspect, one or more embodiments of the present disclosure provide a database synchronization method, comprising:
reading an incremental log stream of a first database and caching the incremental log stream into a memory;
in any round of iteration, sending incremental log data in the incremental log stream to a second database in sequence from a first position in the incremental log stream cached in the memory, and marking a second position of incremental log data which is latest sent to the second database in real time, wherein the first position is a start position of sending the incremental log data to the second database in the round of iteration;
reading any to-be-read data block in the first database and pausing sending the incremental log data to the second database, wherein the to-be-read data block includes at least one row of data in the first database;
filtering out old-version data in the to-be-read data block based on the incremental log data between the first position and the second position and a preset filtering rule, and sending filtered data to the second database; and
moving the first position to the current second position and continuing a next round of iteration.

According to one or more embodiments of the present disclosure, the filtering out the old-version data in the to-be-read data block based on the incremental log data between the first position and the second position and the preset filtering rule comprises:
filtering out data in the to-be-read data block whose primary key is included in the primary key of the incremental log data between the first position and the second position; and
filtering out data in the to-be-read data block whose primary key is not included in the primary key of the incremental log data between the first position and the second position and whose time stamp is not greater than the time stamp corresponding to the first identification.

According to one or more embodiments of the present disclosure, sending the filtered data to the second database comprises:
determining data in the to-be-read data block whose primary key is not included in the primary key of the incremental log data between the first position and the second position and whose time stamp is greater than the time stamp corresponding to the first identification as the filtered data, and sending the filtered data to the second database.

According to one or more embodiments of the present disclosure, the method further comprises:
ending the iteration process after all data blocks in the first database are completely read, and continuing to send incremental log data to the second database.

According to one or more embodiments of the present disclosure, the method further comprises:
ending the iteration process and sending the remaining to-be-read data block to the second database in the case that there is no incremental log data in the incremental log stream to be sent to the second database and there are still remaining to-be-read data blocks in the first database; and
continuing to send the newly read incremental log data to the second database when new incremental log data is read from the incremental log stream.

According to one or more embodiments of the present disclosure, sending incremental log data in the incremental log stream to the second database in sequence from the first position in the incremental log stream in any round of iteration comprises:
adding a first identification to the first position in the incremental log stream in the memory, and sending incremental log data in the incremental log stream to the second database in sequence from the first identification;
marking the second position of the incremental log data which is latest sent to the second database in real time comprises:
adding a second identification to the second position in the incremental log stream in the memory, and updating the position of the second identification in real time; and
moving the first position to the current second position comprises:
moving the first identification to the current second identification.

According to one or more embodiments of the present disclosure, before reading any to-be-read data block in the first database, the method further comprises:
dividing data in the first database into multiple data blocks, wherein any data block includes at least one row of data.

In a second aspect, one or more embodiments of the present disclosure provide a database synchronization device, comprising:
an incremental log stream reading unit, configured to read an incremental log stream of a first database and cache the incremental log stream into a memory;
a synchronization unit, configured to: in any round of iteration, send incremental log data in the incremental log stream to a second database in sequence from a first position in the incremental log stream cached in the memory, and mark a second position of incremental log data which is latest sent to the second database in real time, wherein the first position is a start position of sending the incremental log data to the second database in the round of iteration;
a data block scanning unit, configured to read any to-be-read data block in the first database and pause sending the incremental log data to the second database, wherein the to-be-read data block includes at least one row of data in the first database;
a filtering unit, configured to filter out old-version data in the to-be-read data block based on the incremental log data between the first position and the second position and a preset filtering rule; and
the synchronization unit is further configured to send filtered data to the second database, move the first position to the current second position, and continue a next round of iteration.

According to one or more embodiments of the present disclosure, the filtering unit, when filtering out the old-version data in the to-be-read data block according to the incremental log data between the first position and the second position and the preset filtering rule, is configured to:
filter out data in the to-be-read data block whose primary key is included in the primary key of the incremental log data between the first position and the second position; and
filter out data in the to-be-read data block whose primary key is not included in the primary key of the incremental log data between the first position and the second position and whose time stamp is not greater than the time stamp corresponding to the first identification.

According to one or more embodiments of the present disclosure, the filtering unit is configured to:
determine data in the to-be-read data block whose primary key is not included in the primary key of the incremental log data between the first position and the second position and whose time stamp is greater than the time stamp corresponding to the first identification as the filtered data, to be sent to the second database.

According to one or more embodiments of the present disclosure, the synchronization unit is further configured to:
end the iteration process after all data blocks in the first database are completely read, and continue to send incremental log data to the second database.

According to one or more embodiments of the present disclosure, the synchronization unit is further configured to:
end the iteration process and send the remaining to-be-read data block to the second database in the case that there is no incremental log data in the incremental log stream to be sent to the second database and there are still remaining to-be-read data blocks in the first database; and
continue to send the newly read incremental log data to the second database when new incremental log data is read from the incremental log stream.

According to one or more embodiments of the present disclosure, the synchronization unit, when in any round of iteration, sending incremental log data in the incremental log stream to the second database in sequence from the first position in the incremental log stream, is configured to:
add a first identification to the first position in the incremental log stream in the memory, and send incremental log data in the incremental log stream to the second database in sequence from the first identification.

The synchronization unit, when marking the second position of the incremental log data which is latest sent to the second database in real time, is configured to:
add a second identification to the second position in the incremental log stream in the memory, and update the position of the second identification in real time.

The synchronization unit, when moving the first position to the current second position, is configured to:
move the first identification to the current second identification.

According to one or more embodiments of the present disclosure, the data block scanning unit, before reading any to-be-read data block in the first database, is further configured to:
divide data in the first database into multiple data blocks, wherein any data block includes at least one row of data.

In a third aspect, one or more embodiments of the present disclosure provide an electronic device, comprising: at least one processor and a memory;
wherein the memory stores computer-executable instructions; and
the at least one processor executes the computer-executable instructions stored in the memory, to cause the at least one processor to execute the database synchronization method according to the above first aspect and various possible designs of the first aspect.

In a fourth aspect, one or more embodiments of the present disclosure provide a computer-readable storage medium, wherein the computer-readable storage medium stores computer-executable instructions, and when the computer-executable instructions are executed by a processor, the database synchronization method according to the above first aspect and various possible designs of the first aspect is implemented.

In a fifth aspect, one or more embodiments of the present disclosure provide a computer program product, comprising computer-executable instructions, when the computer-executable instructions are executed by a processor, the database synchronization method according to the above first aspect and various possible designs of the first aspect is implemented.

The above description is merely preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept. For example, the technical solution formed by replacing the above features with the technical features disclosed in the present disclosure (but not limited to) with similar functions.

In addition, although operations are depicted in a particular order, this should not be understood as requiring these operations to be performed in the specific order shown or in a sequential order. Under certain circumstances, multitasking and parallel processing may be advantageous. Similarly, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments separately or in any suitable sub-combination.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

I/We claim:

1. A database synchronization method, comprising:
reading an incremental log stream of a first database and caching the incremental log stream into a memory;
in any round of iteration, sending incremental log data in the incremental log stream to a second database in sequence from a first position in the incremental log stream cached in the memory, and marking a second position of incremental log data which is latest sent to the second database in real time, wherein the first position is a start position of sending the incremental log data to the second database in the round of iteration;
reading any to-be-read data block in the first database and pausing sending the incremental log data to the second database, wherein the to-be-read data block comprises at least one row of data in the first database;
filtering out old-version data in the to-be-read data block based on the incremental log data between the first position and the second position and a preset filtering rule, and sending the filtered data to the second database; and
moving the first position to a current second position and continuing a next round of iteration.

2. The method according to claim 1, wherein filtering out the old-version data in the to-be-read data block based on the incremental log data between the first position and the second position and the preset filtering rule comprises:
filtering out data in the to-be-read data block whose primary key is comprised in the primary key of the incremental log data between the first position and the second position; and
filtering out data in the to-be-read data block whose primary key is not comprised in the primary key of the incremental log data between the first position and the second position and whose time stamp is not greater than the time stamp corresponding to a first identification.

3. The method according to claim 1, wherein sending the filtered data to the second database comprises:
determining data in the to-be-read data block whose primary key is not comprised in the primary key of the incremental log data between the first position and the second position and whose time stamp is greater than the time stamp corresponding to a first identification as the filtered data, and sending the filtered data to the second database.

4. The method according to claim 1, further comprising:
ending the iteration process after all data blocks in the first database are completely read, and continuing to send the incremental log data to the second database.

5. The method according to claim 1, further comprising:
in a case that there is no incremental log data in the incremental log stream to be sent to the second database and there is still a remaining to-be-read data block in the first database, ending the iteration process and sending the remaining to-be-read data block to the second database; and
continuing to send new incremental log data to the second database in a case that the new incremental log data is read from the incremental log stream.

6. The method according to claim 1, wherein in any round of iteration, sending the incremental log data in the incremental log stream to the second database in sequence from the first position in the incremental log stream comprises:
adding a first identification to the first position in the incremental log stream in the memory, and sending the incremental log data in the incremental log stream to the second database in sequence from the first identification;
marking the second position of the incremental log data which is latest sent to the second database in real time comprises:
adding a second identification to the second position in the incremental log stream in the memory, and updating a position of the second identification in real time; and
moving the first position to the current second position comprises:
moving the first identification to the current second identification.

7. The method according to claim 1, wherein before reading any to-be-read data block in the first database, the method further comprises:
dividing data in the first database into multiple data blocks, wherein any data block comprises at least one row of data.

8. An electronic device, comprising: at least one processor and a memory;
wherein the memory stores computer-executable instructions; and
the at least one processor executes the computer-executable instructions stored in the memory, to cause the at least one processor to:
read an incremental log stream of a first database and cache the incremental log stream into a memory;
in any round of iteration, send incremental log data in the incremental log stream to a second database in sequence from a first position in the incremental log stream cached in the memory, and mark a second position of incremental log data which is latest sent to the second database in real time, wherein the first position is a start position of sending the incremental log data to the second database in the round of iteration;
read any to-be-read data block in the first database and pause sending the incremental log data to the second database, wherein the to-be-read data block comprises at least one row of data in the first database;
filter out old-version data in the to-be-read data block based on the incremental log data between the first position and the second position and a preset filtering rule, and send the filtered data to the second database; and
move the first position to a current second position and continuing a next round of iteration.

9. The electronic device according to claim 8, wherein the computer-executable instructions causing the at least one processor to filter out the old-version data in the to-be-read data block based on the incremental log data between the first position and the second position and the preset filtering rule comprise instructions to:
filter out data in the to-be-read data block whose primary key is comprised in the primary key of the incremental log data between the first position and the second position; and
filter out data in the to-be-read data block whose primary key is not comprised in the primary key of the incremental log data between the first position and the second position and whose time stamp is not greater than the time stamp corresponding to a first identification.

10. The electronic device according to claim 8, wherein the computer-executable instructions causing the at least one processor to send the filtered data to the second database comprise instructions to:
determine data in the to-be-read data block whose primary key is not comprised in the primary key of the incremental log data between the first position and the second position and whose time stamp is greater than the time stamp corresponding to a first identification as the filtered data, and send the filtered data to the second database.

11. The electronic device according to claim 8, the computer-executable instructions further comprise instructions to:
end the iteration process after all data blocks in the first database are completely read, and continue to send the incremental log data to the second database.

12. The electronic device according to claim 8, the computer-executable instructions further comprise instructions to:
in a case that there is no incremental log data in the incremental log stream to be sent to the second database and there is still a remaining to-be-read data block in the first database, end the iteration process and send the remaining to-be-read data block to the second database; and
continue to send new incremental log data to the second database in a case that the new incremental log data is read from the incremental log stream.

13. The electronic device according to claim 8, wherein the computer-executable instructions causing the at least one processor to in any round of iteration, send the incremental log data in the incremental log stream to the second database in sequence from the first position in the incremental log stream comprise instructions to:
add a first identification to the first position in the incremental log stream in the memory, and send the incremental log data in the incremental log stream to the second database in sequence from the first identification;
mark the second position of the incremental log data which is latest sent to the second database in real time, comprising:
adding a second identification to the second position in the incremental log stream in the memory, and updating a position of the second identification in real time; and
move the first position to the current second position, comprising:
moving the first identification to the current second identification.

14. The electronic device according to claim 8, wherein before reading any to-be-read data block in the first database, the computer-executable instructions further comprise instructions to:
divide data in the first database into multiple data blocks, wherein any data block comprises at least one row of data.

15. A non-transitory computer-readable storage medium, wherein the computer-readable storage medium stores computer-executable instructions therein, and the computer-executable instructions, when executed by a processor, cause the processor to:
read an incremental log stream of a first database and cache the incremental log stream into a memory;
in any round of iteration, send incremental log data in the incremental log stream to a second database in sequence from a first position in the incremental log stream cached in the memory, and mark a second position of incremental log data which is latest sent to the second database in real time, wherein the first position is a start position of sending the incremental log data to the second database in the round of iteration;
read any to-be-read data block in the first database and pause sending the incremental log data to the second database, wherein the to-be-read data block comprises at least one row of data in the first database;
filter out old-version data in the to-be-read data block based on the incremental log data between the first position and the second position and a preset filtering rule, and sending the filtered data to the second database; and
move the first position to a current second position and continuing a next round of iteration.

16. The storage medium according to claim 15, wherein the computer-executable instructions causing the processor to filter out the old-version data in the to-be-read data block based on the incremental log data between the first position and the second position and the preset filtering rule comprise instructions to:
filter out data in the to-be-read data block whose primary key is comprised in the primary key of the incremental log data between the first position and the second position; and
filter out data in the to-be-read data block whose primary key is not comprised in the primary key of the incremental log data between the first position and the second position and whose time stamp is not greater than the time stamp corresponding to a first identification.

17. The storage medium according to claim 15, wherein the computer-executable instructions causing the processor to send the filtered data to the second database comprise instructions to:
determine data in the to-be-read data block whose primary key is not comprised in the primary key of the incremental log data between the first position and the second position and whose time stamp is greater than the time stamp corresponding to a first identification as the filtered data, and send the filtered data to the second database.

18. The storage medium according to claim 15, wherein the computer-executable instructions further comprise instructions to:
end the iteration process after all data blocks in the first database are completely read, and continue to send the incremental log data to the second database.

19. The storage medium according to claim 15, wherein the computer-executable instructions further comprise instructions to:
in a case that there is no incremental log data in the incremental log stream to be sent to the second database and there is still a remaining to-be-read data block in the first database, end the iteration process and send the remaining to-be-read data block to the second database; and
continue to send new incremental log data to the second database in a case that the new incremental log data is read from the incremental log stream.

20. The storage medium according to claim 15, wherein the computer-executable instructions causing the processor to in any round of iteration, send the incremental log data in the incremental log stream to the second database in sequence from the first position in the incremental log stream comprise instructions to:
add a first identification to the first position in the incremental log stream in the memory, and send the incremental log data in the incremental log stream to the second database in sequence from the first identification;
mark the second position of the incremental log data which is latest sent to the second database in real time, comprising:
adding a second identification to the second position in the incremental log stream in the memory, and updating a position of the second identification in real time; and
move the first position to the current second position, comprising:
moving the first identification to the current second identification.
